(19) United States
(12) Patent Application Publication
(10) Pub. No.: US 2025/0333091 A1
(43) Pub. Date: Oct. 30, 2025

(54) EASY-TO-USE Cart

(71) Applicant: Peng XUE, Shanxi (CN)

(72) Inventor: Peng XUE, Shanxi (CN)

(21) Appl. No.: 18/644,878

(22) Filed: Apr. 24, 2024

(51) Int. Cl. B62B 3/02

(52) U.S. Cl. CPC B62B 3/022; B62B 2205/30

(57) ABSTRACT

An easy-to-use cart comprises a frame with wheels, wherein the frame comprises a lower frame, a main frame and connecting tubes; the main frame is provided with fixing portions, and the lower frame has joint portions that are configured to receive the fixing portions so that the main frame is detachably joined to the lower frame; the lower frame is provided with connecting members, two ends of each connecting tube are hinged to the corresponding connecting member and the main frame respectively, and the main frame is liftable and turntable relative to the lower frame by virtue of the connecting tubes; and each connecting member is provided with a receiving space, the receiving space has a minimum height, at least a part of the main frame is received in the receiving space and has a maximum thickness, and the minimum height is not less than the maximum thickness.

### TECHNICAL FIELD

The present invention relates to the technical field of carts and, in particular, to an easy-to-use cart.

### BACKGROUND

At present, objects required for work are often transported to destinations by carts. Different objects require different carts. However, there have been on the market carts that can be converted to different use modes according to different objects. Such carts can be converted between a flatbed cart mode and a hand truck mode. However, during the conversion process of such a cart, parts of the cart need to be detached and repositioned to complete mode conversion. So, the mode conversion process involves more operation steps, and the conversion operation is complicated.

For example, U.S. patent Ser. No. 16/189,957 discloses a folding support rail and tongue for converting a hand truck into a flatbed cart, where, by adjusting the support rail and the tongue, a cart can be converted between a hand truck mode and a flatbed cart mode. However, during the conversion process, handlebars of the cart need to be detached and repositioned to complete the use mode conversion. This will increase the operational complexity of users.

In view of the above problems, it is desired to provide a novel cart that has a simple structure and does not require additional operations for detaching parts during mode conversion. It takes a few steps to convert the use mode of the cart and the conversion operation is simple, thereby greatly improving the mode conversion efficiency of the cart. Moreover, the cart also has the advantage of being suitable for objects of different thicknesses and sizes.

### SUMMARY

The present invention provides an easy-to-use cart, comprising a frame with wheels,
the frame comprises a lower frame, a main frame and connecting tubes; and
the main frame is provided with fixing portions, and the lower frame has joint portions that are configured to receive the fixing portions to allow the main frame to be vertically joined to the lower frame; and
the lower frame is provided with connecting members, two ends of each connecting tube are hinged to the corresponding connecting member and the main frame respectively, wherein the main frame is liftable and turntable relative to the lower frame by virtue of the connecting tubes to separate the joint portions from the fixing portions; and
each connecting member is provided with a receiving space, the receiving space has a minimum height, at least a part of the main frame is received in the receiving space, the part of the main frame received in the receiving space has a maximum thickness, and the minimum height is not less than the maximum thickness to allow the main frame to be laid on the lower frame after being turned.

The present invention further provides an easy-to-use cart, comprising a frame with wheels,
the frame comprises a lower frame, a main frame and connecting tubes; and
the lower frame is provided with width adjustment mechanisms that are rotationally connected to the lower frame; and the main frame is provided with a height adjustment mechanism that is extendable relative to the main frame; and
the main frame is provided with fixing portions, and the lower frame has joint portions that are configured to receive the fixing portions to allow the main frame to be vertically joined to the lower frame; and
the lower frame is provided with connecting members, two ends of each connecting tube are hinged to the corresponding connecting member and the main frame respectively, wherein the main frame is liftable and turntable relative to the lower frame by virtue of the connecting tubes to separate the joint portions from the fixing portions; and
each connecting member is provided with a receiving space, the receiving space has a minimum height, at least a part of the main frame is received in the receiving space, the part of the main frame received in the receiving space has a maximum thickness, and the minimum height is not less than the maximum thickness to allow the main frame to be laid on the lower frame after being turned.

The present invention further provides a method for transporting an object, the method comprising an easy-to-use cart and an object to be transported; and
a cart, comprising a frame with wheels,
the frame comprises a lower frame, a main frame and connecting tubes; and
the main frame is provided with fixing portions, and the lower frame has joint portions that are configured to receive the fixing portions to allow the main frame to be vertically joined to the lower frame; and
the lower frame is provided with connecting members, two ends of each connecting tube are hinged to the corresponding connecting member and the main frame respectively, wherein the main frame is liftable and turntable relative to the lower frame by virtue of the connecting tubes to separate the joint portions from the fixing portions; and
each connecting member is provided with a receiving space, the receiving space has a minimum height, at least a part of the main frame is received in the receiving space, the part of the main frame received in the receiving space has a maximum thickness, and the minimum height is not less than the maximum thickness to allow the main frame to be laid on the lower frame after being turned; and
the method comprising:
when the cart needs to be converted to a hand truck mode, turning the main frame over and fixing the fixing portions in the joint portions so that the main frame is vertically locked to the lower frame; and
placing the object on the cart; and
moving the cart to transport the object; and
when the cart needs to be converted to a flatbed cart mode, lifting and turning the main frame so that the main frame is laid on the lower frame and the main frame is parallel to the ground; and
placing the object on the main frame; and
moving the cart to transport the object.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the detailed description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of a cart according to the present invention;

FIG. 2 is a schematic diagram of the cart according to the present invention;

FIG. 3 is a schematic diagram of a lower frame according to the present invention;

FIG. 4 is a schematic diagram of the lower frame according to the present invention;

FIG. 5 is a schematic diagram of the lower frame according to the present invention;

FIG. 6 is a schematic diagram of a raised portion according to the present invention;

FIG. 7 is a schematic diagram of a main frame according to the present invention;

FIG. 8 is a schematic diagram of the main frame according to the present invention;

FIG. 9 is an enlarged schematic diagram of part A in FIG. 8;

FIG. 10 is an enlarged schematic diagram of part B in FIG. 8;

FIG. 11 is a schematic diagram of the main frame according to the present invention;

FIG. 12 is an enlarged schematic diagram of part C in FIG. 11;

FIG. 13 is a schematic diagram of the cart according to the present invention;

FIG. 14 is an enlarged schematic diagram of part D in FIG. 13;

FIG. 15 is a schematic diagram of the cart according to the present invention in a hand truck mode;

FIG. 16 is a schematic diagram of the cart according to the present invention in a flatbed cart mode;

In the figures,
frame (1); lower frame (1000); first border (1100); first end (1110); maximum height (H); width adjustment mechanism (1112); second end (1120); connecting member (1121); first connecting portion (1122); rotating member (1123); placement stand (1124); receiving space (1125); extension arm (1130); fixing portion (1150); joint portion (1160); storage stand (1170); wheel (1140); main frame (2000); fastener (2100); second border (2200); crossbar (2210); second connecting portion (2211); height adjustment mechanism (2220); locking hole (2221); locking mechanism (2222); fixing belt (2230); connecting tube (3000); minimum height (X); maximum thickness (Y).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

As a preferred embodiment of the present invention, to simplify the structure of carts, avoid additional operations for detaching parts during mode conversion, realize simple operation and few steps, and improve the mode conversion efficiency of carts, the present invention provides an easy-to-use cart.

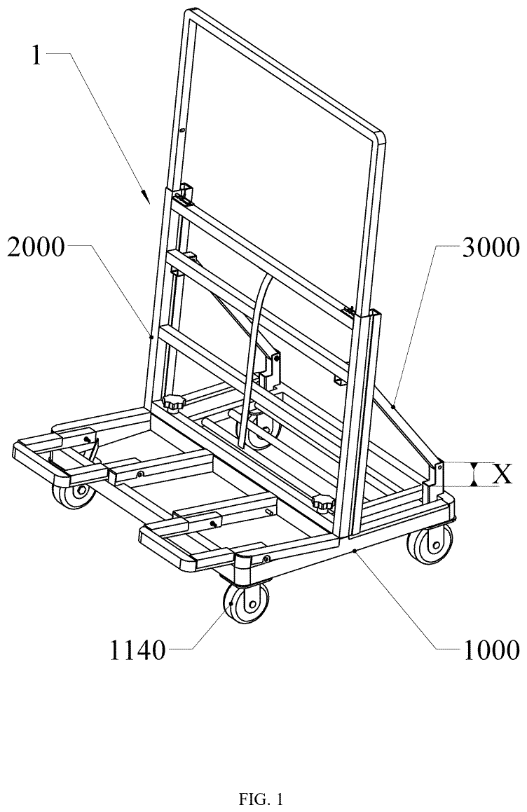

Referring to FIG. 1, the cart comprises a frame 1, and wheels 1140 are provided at a bottom of the frame 1. The wheels 1140 are universal wheels by which the cart can be moved in any direction.

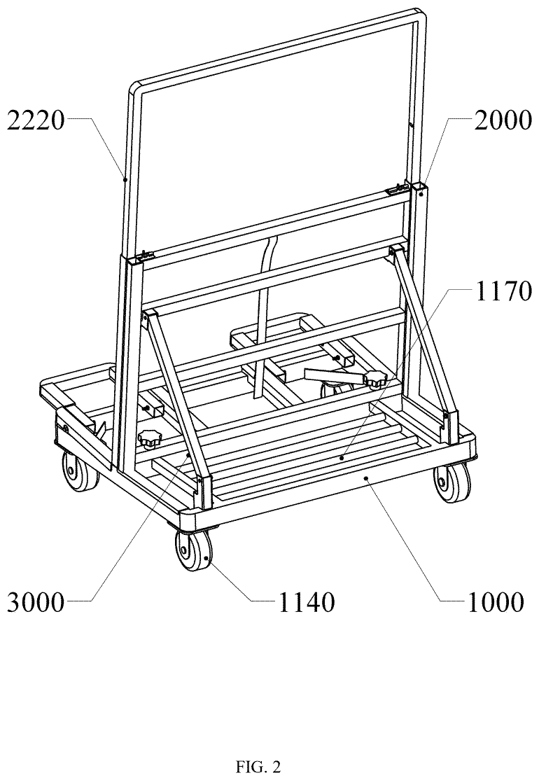

Referring to FIGS. 1 and 2, the frame 1 comprises a lower frame 1000, a main frame 2000 and connecting tubes 3000. The wheels 1140 are provided at a bottom of the lower frame 1000.

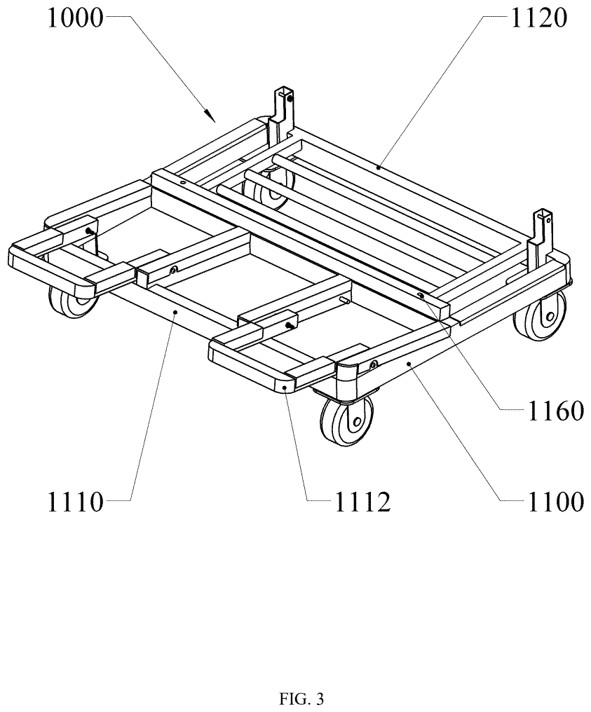

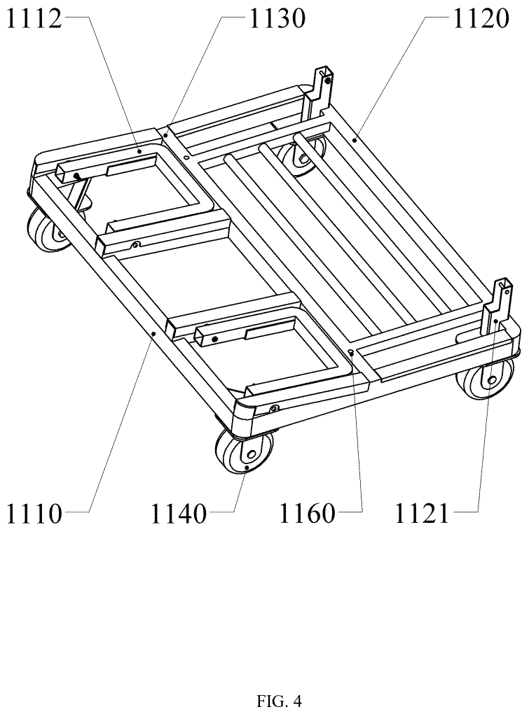

Referring to FIGS. 3 and 4, the main frame 2000 is provided with fixing portions 1150. In this embodiment, the fixing portions 1150 are configured as pins for fixing the main frame 2000 to the lower frame 1000. In other embodiments, the fixing portions 1150 may also be configured as catches, buckles or other fixing members.

Referring to FIGS. 3 and 4, the lower frame 1000 has joint portions 1160. Each joint portion 1160 is configured as a through hole. The fixing portions 1150 can be inserted and fixed in the joint portions 1160, so that the main frame 2000 is detachably joined to the lower frame 1000.

Referring to FIG. 3, the lower frame 1000 comprises a first border 1100 and at least one extension arm 1130, and the extension arm 1130 is fixedly connected to the first border 1100. In this embodiment, the extension arm 1130 and the first border 1100 are formed integrally. In other embodiments (not shown), the extension arm 1130 and the first border 1100 may be in a threaded connection, a snap connection or other connection modes. Further, the join portion 1160 is provided on the extension arm 1130.

Referring to FIGS. 3 and 4, the first border 1100 has a first end 1110 and a second end 1120 opposite to the first end 1110, the first end 1110 is hinged to width adjustment mechanisms 1112, and the width adjustment mechanisms 1112 are turntable in a direction away from the first end 1110 to expand the bearing width of the cart. In this embodiment, two width adjustment mechanisms 1112 are provided. In other embodiments (not shown), as a feature, one, three or more width adjustment mechanisms 1112 may be provided.

Referring to FIG. 4, the lower frame 1000 is provided with connecting members 1121 which extend from the second end 1120 in a direction away from the ground. In this embodiment, the connecting members 1121 are non-detachably fixed to the second end 1120 in a way of being integrally formed on the second end 1120. In other embodiments (not shown), the connecting members 1121 and the second end 1120 may also be fixed by way of threaded connection, welding connection, or snap connection or in other ways. The connecting tubes 3000 are hinged to the tops of the connecting members 1121 so that the connecting tubes 3000 can be rotated relative to the lower frame 1000.

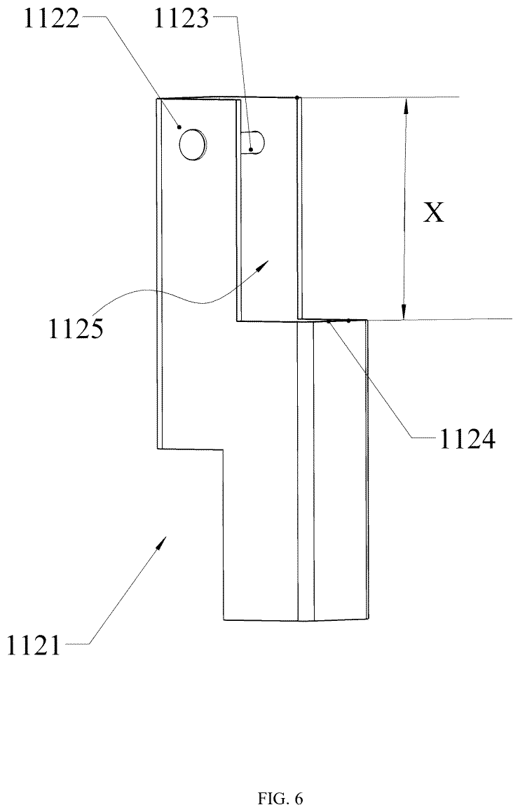

Referring to FIG. 6, the connecting member 1121 comprises a first connecting portion 1122 and a placement stand 1124, the height of the first connecting portion 1122 is greater than that of the placement stand 1124. That is, when the connecting member 1121 is fixed to the lower frame 1000, the first connecting portion 1122 is located at a higher geographical location than the placement stand 1124. The first connecting portion 1122 has a rotating member 1123 inserted therethrough, and the rotating member 1123 allows a rotational connection between the connecting tube 3000 and the first connecting portion 1122.

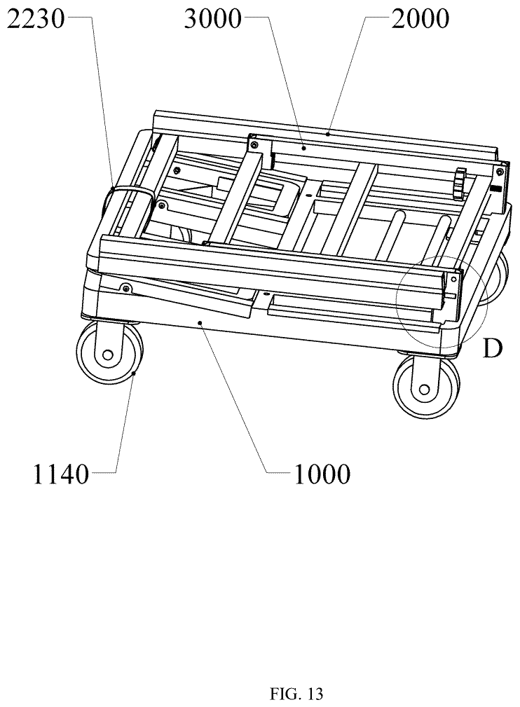

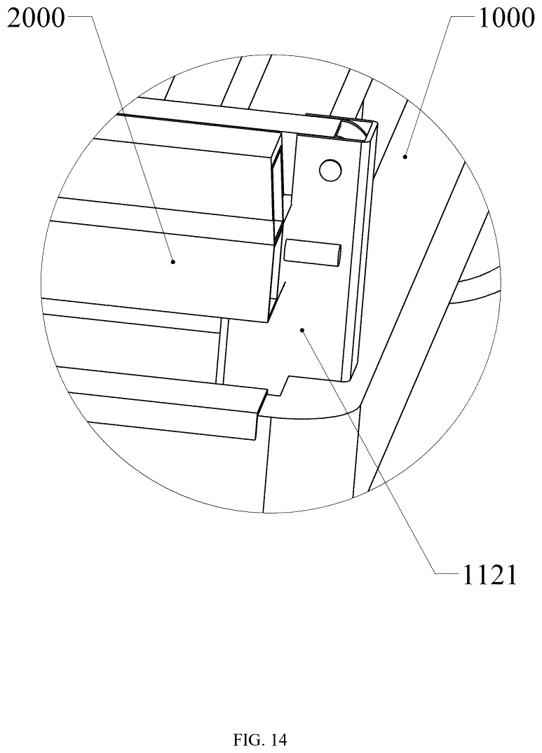

Referring to FIGS. 13 and 14, the main frame 2000 and the connecting tubes 3000 are hinged, so that the main frame 2000 can be turned to be laid on the connecting members 1121.

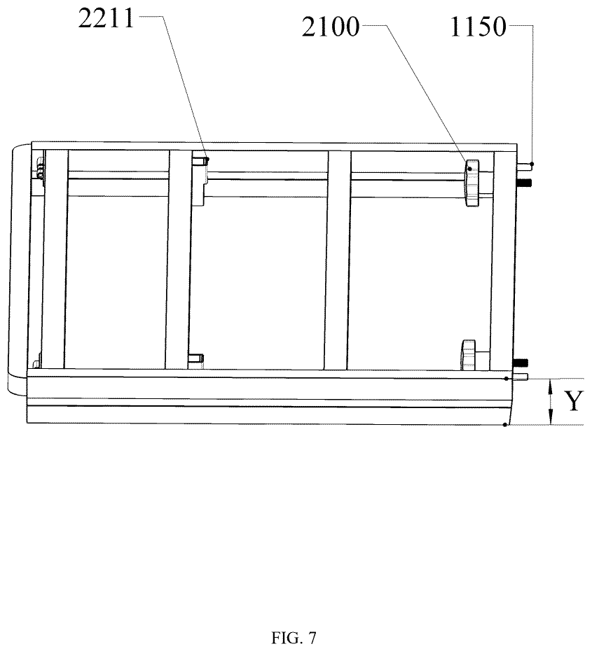

Referring to FIGS. 1 and 6, the connecting member 1121 is provided with a receiving space 1125, the receiving space 1125 has a minimum height X, and the minimum height X is a height from the placement stand 1124 to the top of the first connecting portion 1122. Referring to FIG. 7, a part of the main frame 2000 is received in the receiving space 1125, and the part of the main frame 2000 received in the receiving space 1125 has a maximum thickness Y. That is, when the main frame 2000 is laid flat, the maximum thickness Y is the height of the main frame 2000 laid flat, and the minimum height X is not less than the maximum thickness Y so that the main frame 2000 can be laid on the lower frame 1000 after being turned (as shown in FIGS. 13 and 14).

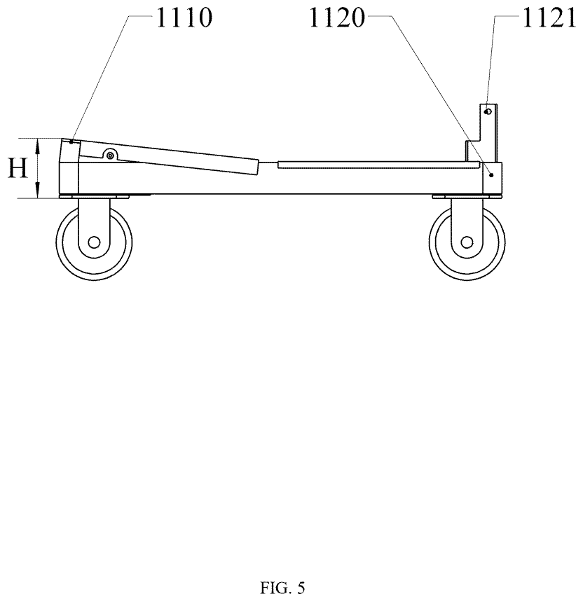

Referring to FIG. 5, the height of the first end 1110 gradually decreases in a direction towards the second end 1120. The height of the first end 1110 is greater than that of the second end 1120. Since a protrusion is provided on the first end 1110, the first end 1110 is in an inclined state. Therefore, the first end 1110 has a maximum height H, which is equal to the height of the placement stand 1124. When the lower frame 1000 is laid flat on the placement stand 1124, the placement stands 1124 and the maximum height H jointly support the main frame 2000 to keep the main frame 2000 basically parallel to the ground.

Further, by virtue of the first end 1110 in the inclined state, the object transported can be placed in an inclined state, so the object does not fall easily and can lean against the main frame 2000 stably.

Referring to FIG. 2, a plurality of rods are provided near the second end 1120. These rods form a storage stand 1170, and the storage stand 1170 is used for storing tools.

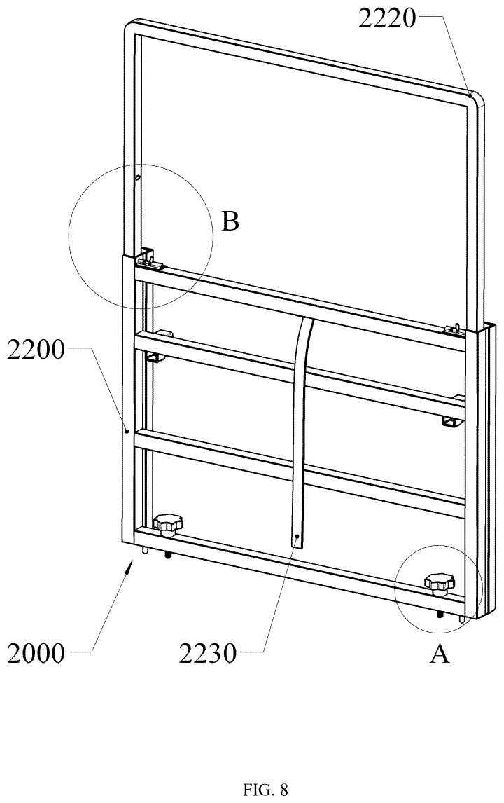

Referring to FIGS. 7 and 8, the main frame 2000 comprises a second border 2200, and the second border 2200 is provided with fasteners 2100. The fasteners 2100 can fix the second border 2200 to the lower frame 1000 through threaded connection, thereby strengthening the connection relationship between the second border 2200 and the lower frame 1000.

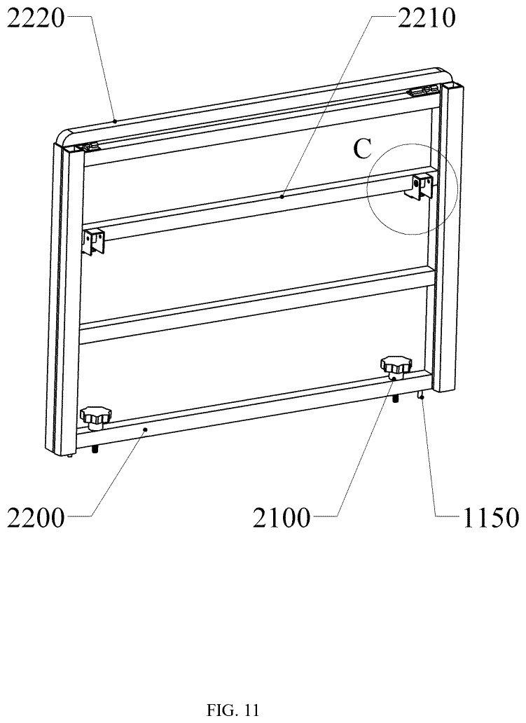

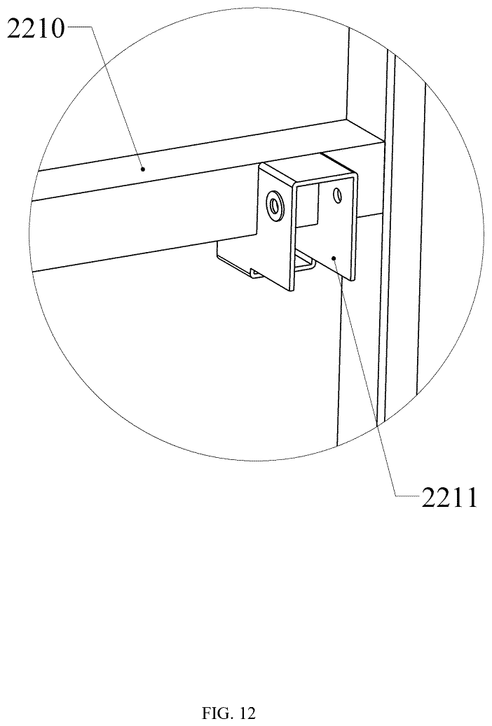

Referring to FIGS. 11 and 12, the second border 2200 comprises at least one crossbar 2210, the crossbar 2210 is inserted in the second border 2200, the crossbar 2210 has a second connecting portion 2211 extending toward the second end 1120, the connecting tube 3000 is hinged to the second connecting portion 2211, so that the main frame 2000 can be flipped relative to the lower frame 1000.

Referring to FIGS. 8 and 11, the main frame 2000 is provided with a height adjustment mechanism 2220, and the height adjustment mechanism 2220 is provided above the second border 2200 and opposite to the fasteners 2100, wherein at least a part of the height adjustment mechanism 2220 is inserted in the main frame 2000, so that the height adjustment mechanism 2220 is extendable relative to the main frame 2000, thereby extending the transport height of the cart.

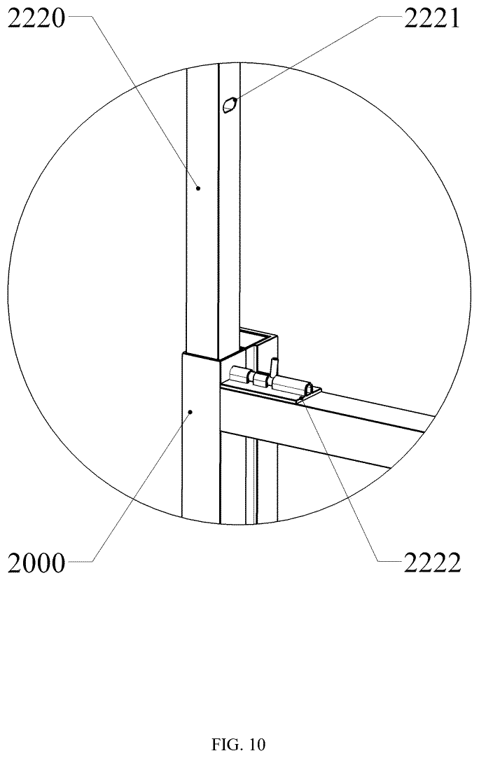

Referring to FIG. 10, the height adjustment mechanism 2220 is controlled by a locking mechanism 2222 and has a locking hole 2221. When the height adjustment mechanism 2220 needs to be held at a certain height, the locking mechanism 2222 is inserted into the locking hole 2221 to hold the height adjustment mechanism 2220 at a certain height.

Referring to FIG. 13, the cart comprises a fixing belt 2230 provided on the main frame 2000, wherein the fixing belt 2230 may be configured to fix the object to be transported, or to fix the main frame 2000 and the lower frame 1000, or the cart can be pulled to move by virtue of the fixing belt 2230.

Specifically, since the connecting tubes 3000 are hinged to the lower frame 1000 and the main frame 2000 and configured to support the main frame 2000 so that the main frame 2000 can be lifted and turned relative to the lower frame 1000. In this way, the cart has a hand truck mode and a flatbed cart mode.

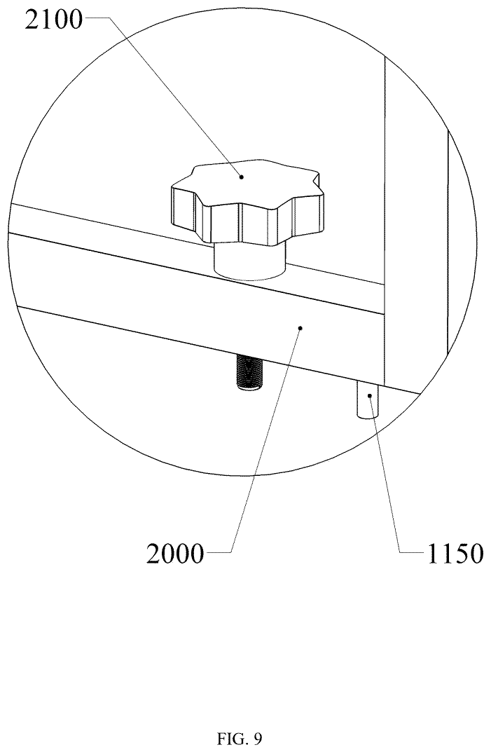

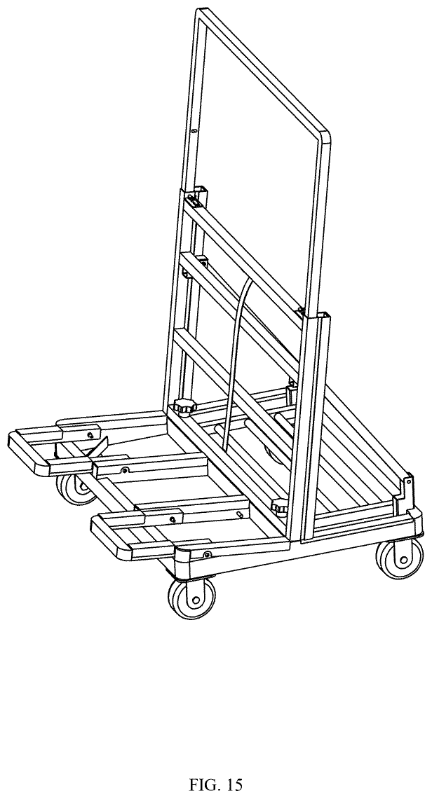

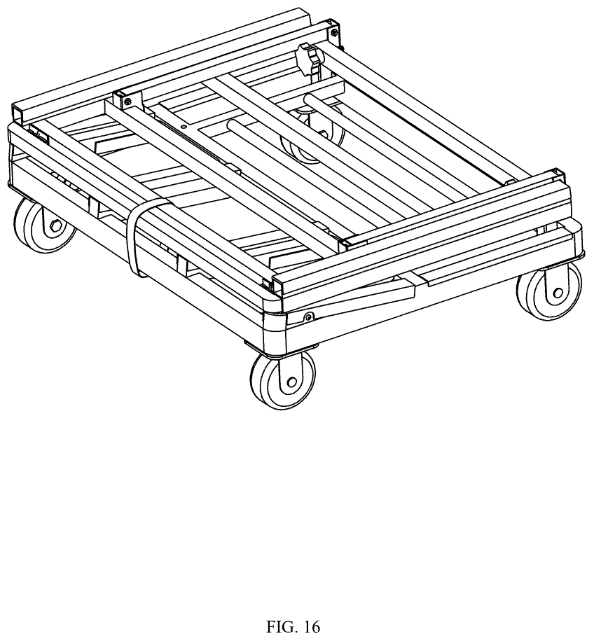

Referring to FIGS. 1-16, as another preferred embodiment of the present invention, the present invention further provides a method for transporting an object. The method comprises an easy-to-use cart and an object to be transported, wherein the cart is the easy-to-use cart.

When the cart needs to be converted to the hand truck mode, the main frame 2000 needs to be turned so that the fixing portions 1150 are fixed to the joint portions 1160, and then the main frame 2000 is locked to the lower frame 1000 by virtue of the fasteners 2100. In this case, there will be an angel between the connecting tubes 3000 and the lower frame 1000 and the connecting tubes 3000 support the main frame 2000 at an angle, so that the main frame 2000 is stably fixed to the lower frame 1000 in a vertical direction. In this case, the cart is in the hand truck mode, and then the object to be transported is placed on the cart, and by virtue of the main frame 2000, the cart is pushed to move.

When the cart needs to be converted to the flatbed cart mode, the fasteners 2100 are loosened from the lower frame 1000, the main frame 2000 are lifted and turned so that the main frame 2000 is laid on the lower frame 1000, and the main frame 2000 is then fixed to the placement stand 1124 and the maximum height H of the first end 1110. In this case, the connecting tubes 3000 do not support the main frame 2000, and the connecting tubes 3000 and the main frame 2000 are in parallel relative to the ground. In this case, the cart is in the flatbed cart mode, and then the object to be transported is placed on the cart and fixed to the cart by virtue of the fixing belt 2230, or the fixing belt 2230 may also be used by users to pull the cart to move instead of being used to fix the object.

In some embodiments (not shown), the first border 1100 is provided with a threaded hole, and a moving belt is connected and fixed to the threaded hole by virtue of a bolt. When the cart is in the flatbed cart mode, users can pull the moving belt to move the cart to transport the object.

After the cart is adjusted to a required position, the width adjustment mechanism 1112 and the height adjustment mechanism 2220 can be adjusted according to the thickness and size of the object, so that the cart can be adapted to the shapes of different objects.

In summary, the easy-to-use cart of the present invention has many advantages in transportation of objects, including but not limited to: flexibility: the cart has two modes: the hand truck mode and the flatbed cart mode; and by the mutual conversion between the hand truck mode and the flatbed cart mode, the cart meets different transportation needs and is suitable for different scenarios; portability: the cart is lightweight in structure and easy to fold without taking up much space, thus being easy to use and store in daily life. In short, the easy-to-use cart is an object transportation tool that is practical and suitable for different scenarios. The cart can also provide users with a comfortable and safe experience and improve transportation efficiency.

In the broad sense of the present invention, the mode conversion structure of the easy-to-use cart can also be applied to other scenarios and equipment, including but not limited to: Shopping: when users are shopping, the cart can help users carry heavy shopping bags or bulky items. Users can place shopping bags on the main frame of the cart in the flatbed cart mode and push the cart around easily. Outdoor activities: if users want to have a picnic, or go camping or hiking outdoors, this cart will be very helpful for the users. Users can put food, tents, sleeping bags and other items on the cart and then take them around easily. Warehouse and logistics: in warehouses, logistics centers or sorting stations, this cart can help staff carry goods and improve work efficiency. In summary, the easy-to-use cart is suitable for various daily life and work scenarios, bringing users with convenience and practicality.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. An easy-to-use cart, comprising a frame with wheels, wherein the frame comprises a lower frame, a main frame and connecting tubes; and
the main frame is provided with fixing portions, and the lower frame has a joint portion that is configured to receive the fixing portions to allow the main frame to be vertically joined to the lower frame; and
the lower frame is provided with connecting members, two ends of each said connecting tube are hinged to the connecting member and the main frame respectively, wherein the main frame is liftable and turntable relative to the lower frame by virtue of the connecting tubes to separate the joint portion from the fixing portions; and
each said connecting member is provided with a receiving space, the receiving space has a minimum height, at least a part of the main frame is received in the receiving space, the part of the main frame received in the receiving space has a maximum thickness, and the minimum height is not less than the maximum thickness to allow the main frame to be laid on the lower frame after being turned.

2. The cart according to claim 1, wherein the lower frame comprises a first border and at least one extension arm, the extension arm is fixedly connected to the first border, and the joint portion is provided on the extension arm.

3. The cart according to claim 2, wherein the first border has a first end and a second end opposite to the first end, wherein the first end is hinged to a width adjustment mechanism, and the width adjustment mechanism is turntable in a direction away from the first end.

4. The cart according to claim 3, wherein the connecting members which extend from the second end in a direction away from ground, the connecting members are non-detachably fixed to the second end, and the connecting tubes are connected and fixed to tops of the connecting members.

5. The cart according to claim 4, wherein the connecting member comprises a first connecting portion and a placement stand, a height of the first connecting portion is greater than that of the placement stand, the first connecting portion has a rotating member inserted therethrough, and the rotating member allows a rotational connection between the connecting tube and the first connecting portion.

6. The cart according to claim 5, wherein a height of the first end gradually decreases in a direction towards the second end, and the first end has a maximum height, which is equal to the height of the placement stand; and when the main frame is laid on the lower frame, the placement stand and the maximum height jointly support the main frame to keep the main frame basically parallel to ground.

7. The cart according to claim 6, wherein the lower frame is provided with a storage stand near the second end; and when the cart is in use, the storage stand is used for storing tools.

8. The cart according to claim 3, wherein the main frame comprises a second border, the second border is provided with a fastener, and the main frame and the extension arm are detachably connected by virtue of the fastener.

9. The cart according to claim 8, wherein the second border comprises at least one crossbar, the crossbar has a second connecting portion extending toward the second end, and the connecting tube is hinged to the second connecting portion.

10. The cart according to claim 9, wherein the main frame is provided with a height adjustment mechanism, and the height adjustment mechanism is provided opposite to the fastener; and the height adjustment mechanism is extendable relative to the main frame, thereby extending a transport height of the cart.

11. The cart according to claim 10, wherein the height adjustment mechanism is controlled by a locking mechanism and has a locking hole, wherein the height adjustment mechanism is extendable relative to the second border, and the locking mechanism is inserted into the locking hole to hold the height adjustment mechanism at a certain height.

12. The cart according to claim 1, wherein the cart comprises a fixing belt provided on the main frame, wherein the fixing belt is configured to fix an object to be transported, or to fix the main frame and the lower frame.

13. An easy-to-use cart, comprising a frame with wheels, wherein the frame comprises a lower frame, a main frame and connecting tubes; and
the lower frame is provided with width adjustment mechanisms that are rotationally connected to the lower frame; and the main frame is provided with a height adjustment mechanism that is extendable relative to the main frame; and
the main frame is provided with fixing portions, and the lower frame has a joint portion that are configured to receive the fixing portions to allow the main frame to be vertically joined to the lower frame; and
the lower frame is provided with connecting members, two ends of each said connecting tube are hinged to the connecting member and the main frame respectively, wherein the main frame are liftable and turntable relative to the lower frame by virtue of the connecting tubes to separate the joint portion from the fixing portions; and
each said connecting member is provided with a receiving space, the receiving space has a minimum height, at least a part of the main frame is received in the receiving space, the part of the main frame received in the receiving space has a maximum thickness, and the minimum height is not less than the maximum thickness to allow the main frame to be laid on the lower frame after being turned.

14. The cart according to claim 13, wherein the lower frame is provided with a storage stand; and when the cart is in use, the storage stand is used for storing tools.

15. The cart according to claim 14, wherein the main frame is provided with fasteners, and fasteners fix the main frame to the lower frame through threaded connection.

16. The cart according to claim 15, wherein the height adjustment mechanism is provided opposite to the fasteners; and at least a part of the height adjustment mechanism is inserted in the main frame.

17. The cart according to claim 16, wherein two width adjustment mechanisms are provided, the width adjustment mechanisms are hinged to the lower frame and are turntable in a direction away from the lower frame.

18. A method for transporting an object, the method comprising an easy-to-use cart and an object to be transported; and
the cart comprising a frame with wheels, wherein the frame comprises a lower frame, a main frame and connecting tubes; and
the main frame is provided with fixing portions, and the lower frame has a joint portion that are configured to receive the fixing portions to allow the main frame to be vertically joined to the lower frame; and
the lower frame is provided with connecting members, two ends of each said connecting tube are hinged to the connecting member and the main frame respectively, wherein the main frame is liftable and turntable relative to the lower frame by virtue of the connecting tubes to separate the joint portion from the fixing portions; and
each said connecting member is provided with a receiving space, the receiving space has a minimum height, at least a part of the main frame is received in the receiving space, the part of the main frame received in the receiving space has a maximum thickness, and the minimum height is not less than the maximum thickness to allow the main frame to be laid on the lower frame after being turned; and
the method comprising:
the cart having a hand truck mode and a flatbed cart mode; and
when the cart needs to be converted to the hand truck mode, turning the main frame and fixing the fixing portions in the joint portion so that the main frame is vertically locked to the lower frame; and
placing the object on the cart; and
moving the cart to transport the object; and
when the cart needs to be converted to the flatbed cart mode, lifting and turning the main frame so that the main frame is laid on the lower frame and the main frame is parallel to ground; and
placing the object on the main frame; and
moving the cart to transport the object.

19. The method according to claim 18, wherein when the cart needs to be converted to the hand truck mode, the main frame is locked to the lower frame in an inclined state, and the main frame and the lower frame are fastened with bolts, and then users move the cart by virtue of the main frame to transport the object.

20. The method according to claim 19, wherein when the cart needs to be converted to the flatbed cart mode, the main frame is lifted to separate the fixing portions from the main frame, the main frame is then turned to lean against the lower frame and be parallel to ground, the object is then placed on the main frame, and users pull the cart by virtue of a fixing belt to transport the object.
